(19) United States
(12) Patent Application Publication
(10) Pub. No.: US 2018/0249779 A1
(43) Pub. Date: Sep. 6, 2018

(54) Helmet Systems And Method For Operating The Same

(71) Applicant: Point Blank Enterprises, Inc., Pompano Beach, FL (US)

(72) Inventors: Andres DeLima, Hallandale, FL (US); Walter Kreidell, Hillsboro, FL (US); Emmanuel Martinez, Hollywood, FL (US)

(21) Appl. No.: 15/910,530

(22) Filed: Mar. 2, 2018

Related U.S. Application Data
(60) Provisional application No. 62/466,898, filed on Mar. 3, 2017.

(51) Int. Cl. A42B 3/22; A42B 3/12; A42B 3/04; B32B 7/02; B32B 5/18; B23K 26/38

(52) U.S. Cl. CPC A42B 3/225; A42B 3/125; A42B 3/223; A42B 3/08; B32B 7/02; B32B 5/18; B23K 26/38; A42B 3/04

(57) ABSTRACT

A helmet system is disclosed. The helmet system includes a body and a face shield assembly. The body is sized for being arranged upon a head of a user. The face shield assembly includes a visor member, a face guard member and at least one lock-down strap. The visor member is rotatably-attached to the body. The face guard member is arranged over the visor member. A first end of the at least one lock-down strap is connected to the face guard member. A second end of the at least one lock-down strap is selectively-attached to the body. A helmet system including a fluid gutter is also disclosed. A method is also disclosed

### CROSS-REFERENCE TO RELATED APPLICATIONS

This U.S. patent application claims priority to U.S. Provisional Application: 62/466,898 filed on Mar. 3, 2017, the disclosure of which is considered part of the disclosure of this application and is hereby incorporated by reference in its entirety.

### FIELD OF THE INVENTION

The disclosure relates to helmet systems and a method for operating the same.

### DESCRIPTION OF THE RELATED ART

Helmets are known. While existing helmets perform adequately for their intended purpose, improvements to helmets are continuously being sought in order to advance the arts.

### BRIEF DESCRIPTION OF THE DRAWINGS

The disclosure will now be described, by way of example, with reference to the accompanying drawings, in which:

FIG. 1 is an exploded perspective view of an exemplary helmet system.

FIG. 2A is an assembled perspective view of the helmet system of FIG. 1 illustrating an exemplary face shield assembly movably-secured to a body of the helmet system in a down orientation.

FIG. 2B is an assembled perspective view of the helmet system of FIG. 1 illustrating the exemplary face shield assembly of FIG. 2A movably-secured to the body of the helmet system in an up orientation.

FIG. 2A′ is a perspective view of an exemplary helmet system illustrating an exemplary face shield assembly movably-secured to a body of the helmet system in a down orientation.

FIG. 2B′ is a perspective view of the helmet system of FIG. 2A′ illustrating a face guard member of the face shield assembly detached from the body of the helmet system and a visor member of the face shield assembly arranged in a down orientation relative to the body.

FIG. 2C′ is a perspective view of the helmet system according to FIG. 2B′ illustrating the visor member of the face shield assembly arranged in an up orientation relative to the body after the face guard member of the face shield assembly has been detached from the body.

FIG. 3 is an exploded perspective view of an exemplary face guard member of the helmet system of FIG. 1.

FIG. 4 is an exploded perspective view of an implement attachment rail assembly and a body of the helmet system of FIG. 1.

FIG. 5 is a cross-sectional view of the helmet system according to line 5-5 of FIG. 2A.

Like reference symbols in the various drawings indicate like elements.

### SUMMARY

One aspect of the disclosure provides a helmet system. The helmet system includes a body and a face shield assembly. The a body sized for being arranged upon a head of a user The face shield assembly includes a visor member, a face guard member and at least one lock-down strap. The visor member is rotatably-attached to the body. The face guard member is arranged over the visor member. A first end of the at least one lock-down strap is connected to the face guard member. A second end of the at least one lock-down strap is selectively-attached to the body.

Implementations of the disclosure may include one or more of the following optional features. For example, the at least one fastener connects the face guard member to the visor member. In some implementations, at least one fastener extends through each of the face guard member, the at least one lock-down strap and the visor member. In other examples, a pair of fasteners rotatably-attaches the visor member to the body. In some instances, a plate band is arranged over the visor member and the pair of fasteners extend through the plate band for attaching the plate band to the visor member.

In some implementations, the face guard defines a plurality of openings formed from one unit of material. In some instances, the plurality of openings are formed by a water jet cutting machine or a laser cutting machine. In some examples, the body is formed from an acrylonitrile butadiene styrene material.

In other implementations, the helmet system may include one or more cushioning members. An inner surface of the body forms a cavity that is shaped for receiving the one or more cushioning members defining a plurality of grooves configured to permit the one or more cushioning members to bend from a substantially flat shape to a substantially non-flat shape for conforming to a non-planar surface defined by the inner surface of the body. In some examples, the one or more cushioning members is defined by a plurality of layers of cushioning material having at least a first layer of cushioning material and a second layer of cushioning material. The first layer of cushioning material is defined by a first Durometer ranging between 45 Durometer and 65 Durometer, and the second layer of cushioning material is defined by a second Durometer ranging between 75 Durometer and 95 Durometer.

In some instances, the helmet system includes an implement attachment rail member extending from an outer surface of the body. The implement attachment rail member may be a Picatinny rail member.

Another aspect of the disclosure provides a helmet system including a body and a fluid gutter. The body includes a dome portion and a perimeter portion extending from the dome portion. The fluid gutter extends along a lower perimeter of the dome portion.

Implementations of the disclosure may include one or more of the following optional features. For example, the fluid gutter is defined by a channel formed by an outer surface of the body having a concave-up outer surface portion. In some examples, the concave-up outer surface portion is defined by a grade extending between a high point of the concave-up outer surface portion and a lower point of the concave-up outer surface portion whereby the lower point of the concave-up outer surface portion is located proximate the perimeter portion of the body for directing fluid toward the perimeter portion of the body.

In some examples, the helmet system further includes a face shield member and a face shield assembly seal member. The face shield assembly includes a visor member rotatably-attached to the body. The face shield assembly seal member is secured to an inner surface of the visor member. The fluid gutter may be defined by the face shield assembly seal member and the a portion of an outer surface of the body whereby an uppermost surface of the face shield assembly seal member extends at a distance above the portion of the outer surface of the body defining the lower perimeter of the dome portion. In some instances, the portion of the outer surface of the body defining the lower perimeter of the dome portion is defined by a concave-up surface portion.

Yet another aspect of the disclosure provides a method. The method includes the steps of: providing a helmet system including a visor member of a face shield assembly rotatably-attached to a body that is sized for being arranged upon a head of a user; arranging a face guard member of the face shield assembly over an outer surface of the visor member; and removably-connecting at least one lock-down strap extending from the face guard member to the body for: securing the face guard member of the face shield assembly to the body and rotatably-securing the visor member of the face shield assembly in a down orientation relative the body.

Implementations of the disclosure may include one or more of the following optional features. For example, the method may include the steps of: securing the face guard member to visor member; detaching the at least one lock-down strap from the body; and rotating the visor member and the face guard secured thereto from the down orientation relative the body to an up orientation relative to the body.

In some implementations, the method may include the steps of: detaching the at least one lock-down strap from the body; arranging the face guard member away from the outer surface of the visor member; and rotating the visor member from the down orientation relative the body to an up orientation relative to the body. The method may also include the step of attaching an implement to an implement attachment rail member extending from an outer surface of the body.

The details of one or more implementations of the disclosure are set forth in the accompanying drawings and the description below. Other aspects, features, and advantages will be apparent from the description and drawings, and from the claims.

### DETAILED DESCRIPTION OF THE INVENTION

The figures illustrate an exemplary implementations of a helmet system and a method for operating the same. Based on the foregoing, it is to be generally understood that the nomenclature used herein is simply for convenience and the terms used to describe the invention should be given the broadest meaning by one of ordinary skill in the art.

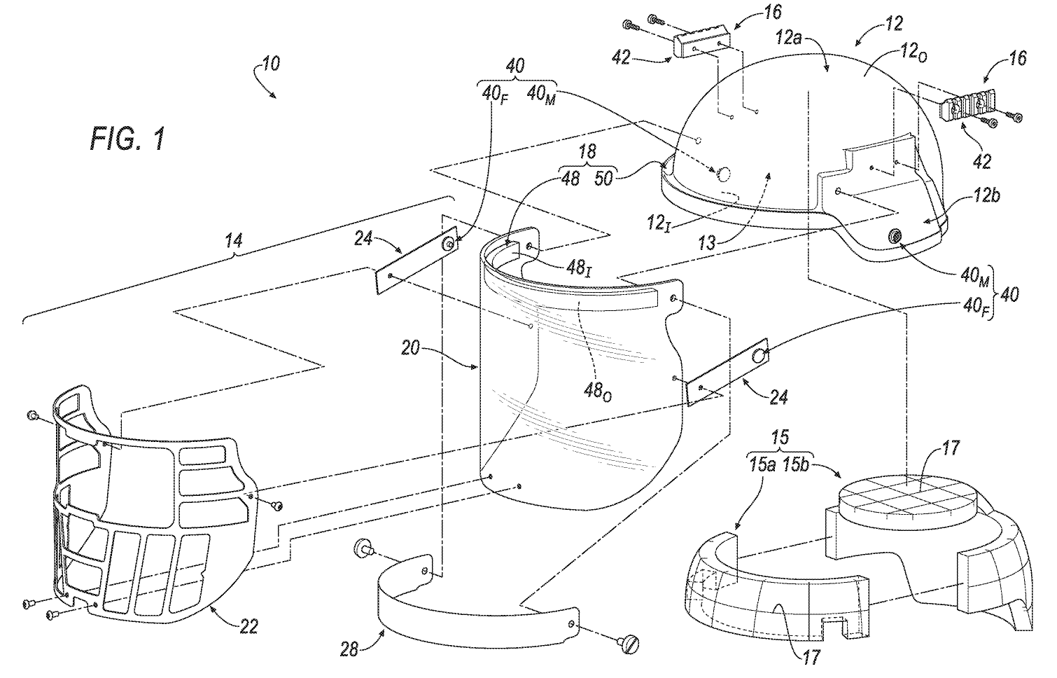

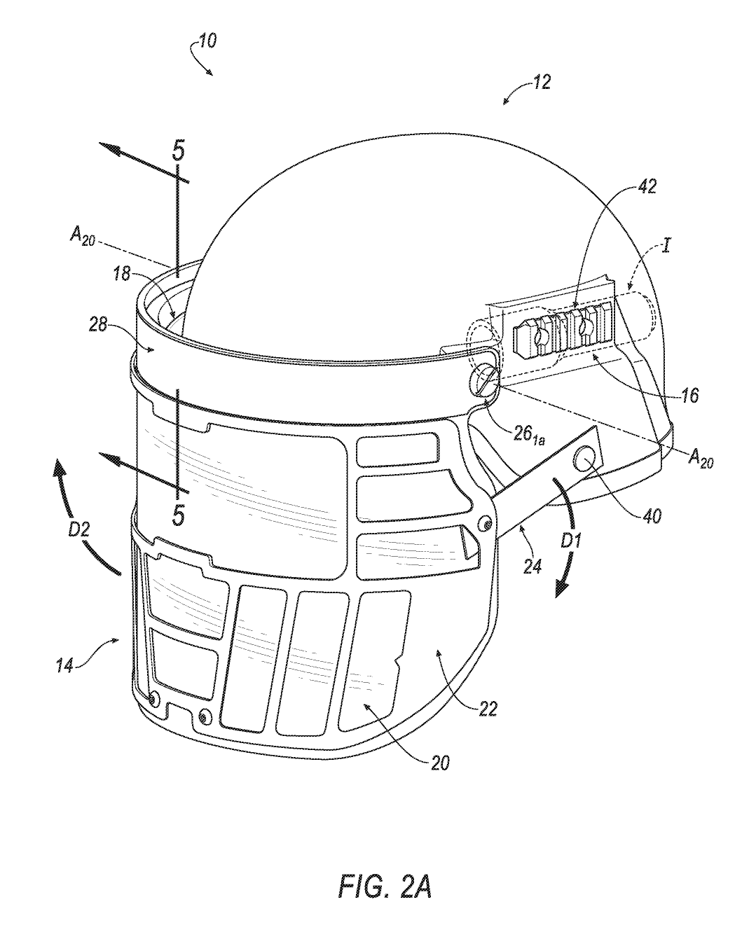

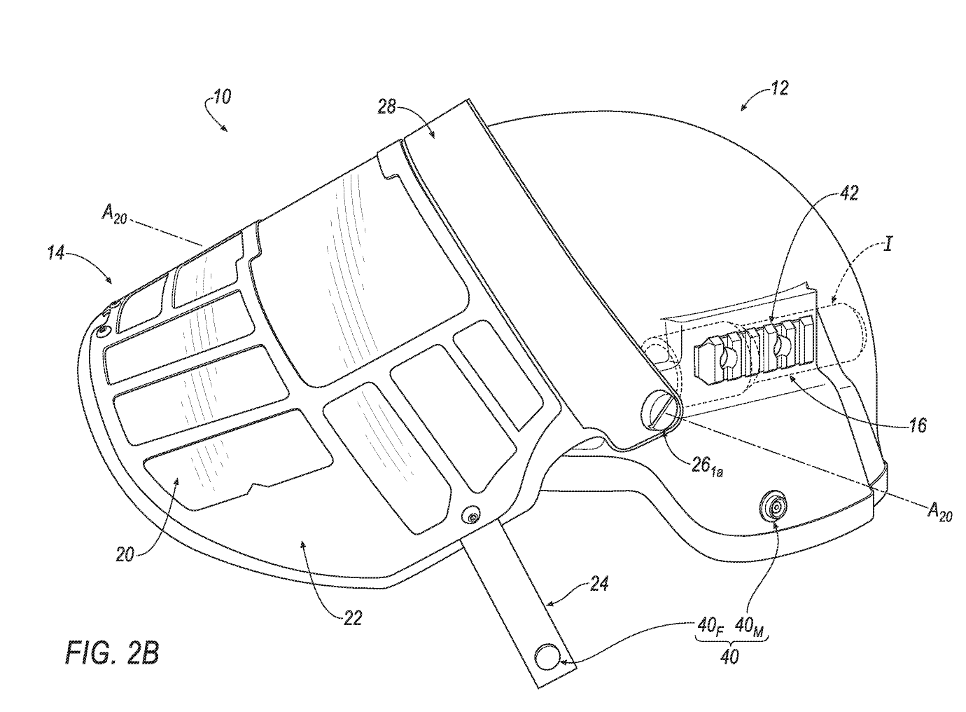

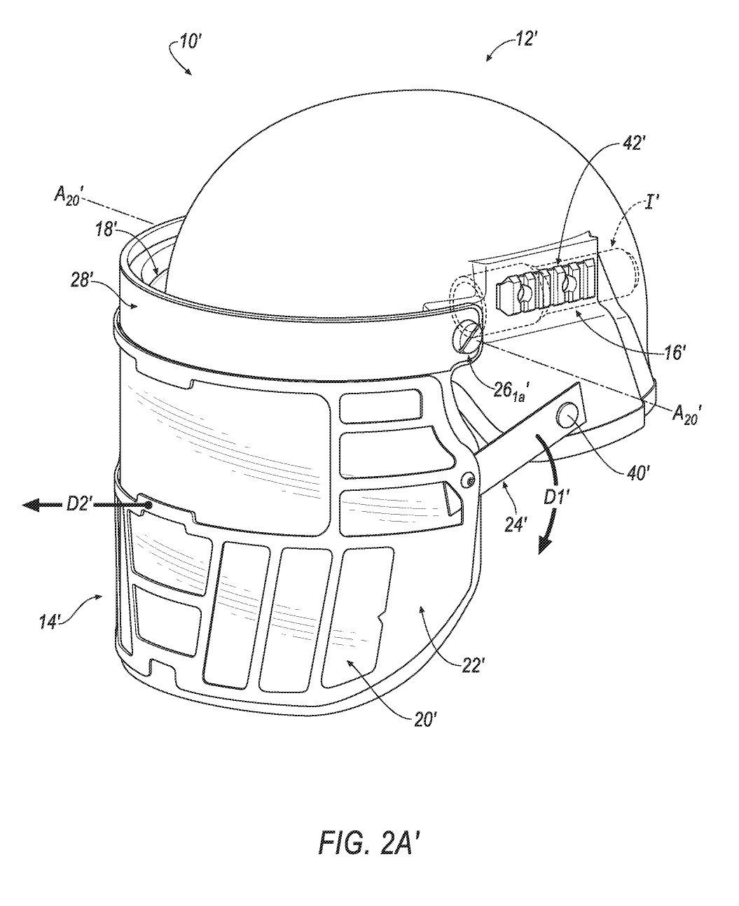

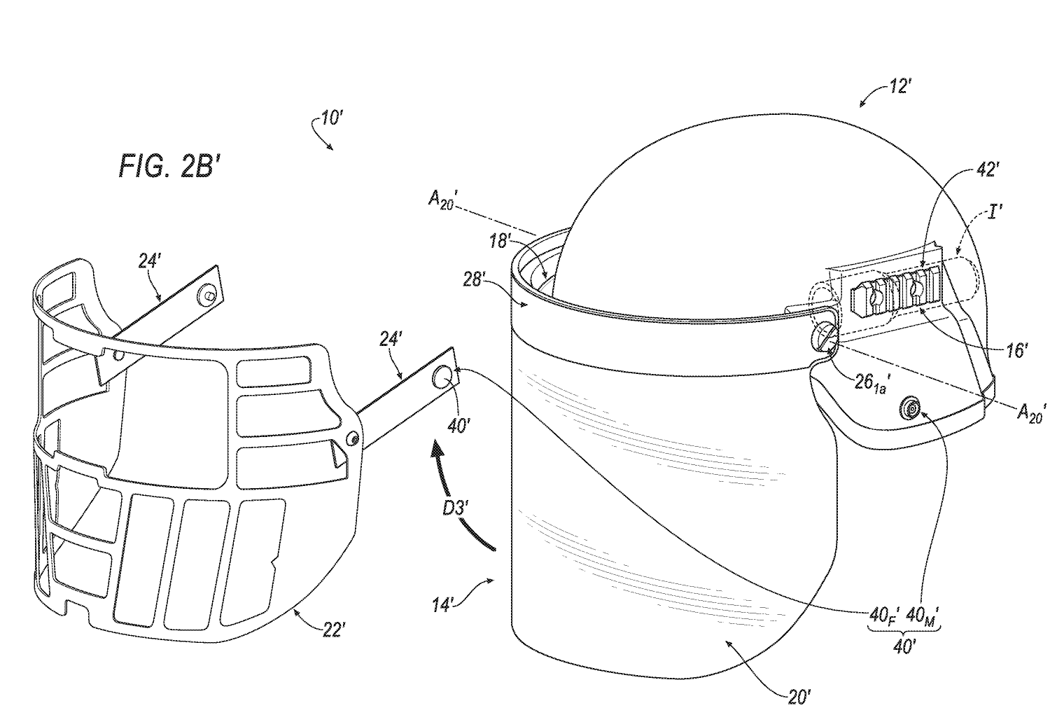

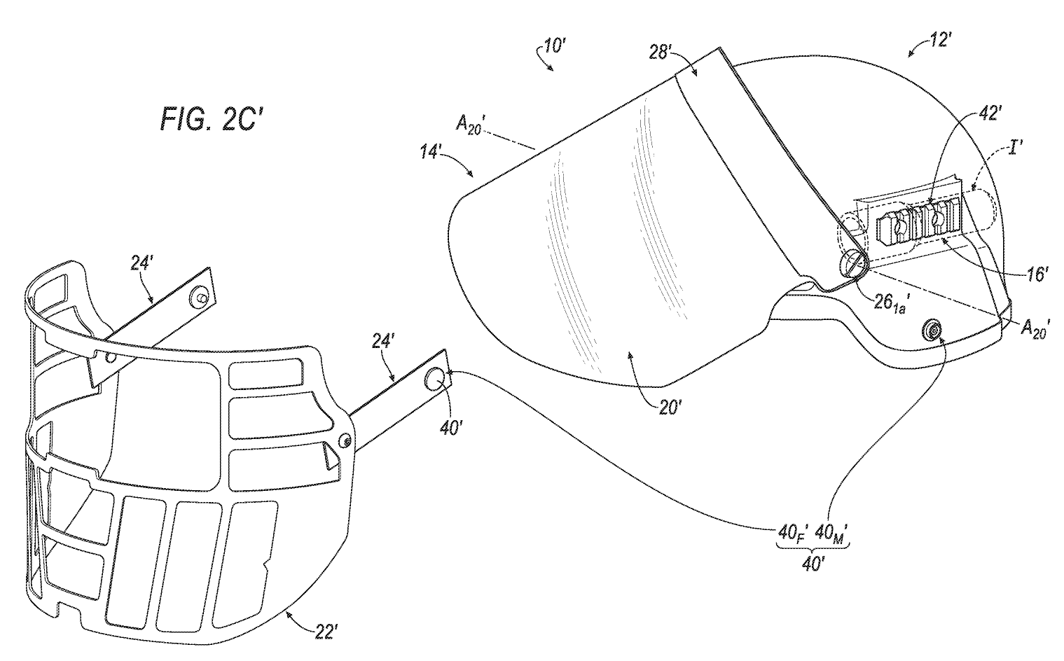

Referring to FIGS. 1, 2A-2B and 2A′-2C′, exemplary helmet systems are shown generally at 10 (see, e.g., FIGS. 1 and 2A-2B) and 10′ (see, e.g., FIGS. 2A′-2C′). As seen in FIG. 1, the helmet system 10 includes a body 12 having an outer surface 12_{O} and an inner surface 12_{I}. The helmet system 10 may further include one or more of a plurality of assemblies/structural components 14-18 attached to the body 12 or integrally-formed-with the body 12. In an implementation, the helmet system 10 may include a face shield assembly 14 that is movably-attached to the body 12. In another example, the helmet system 10 may include an implement attachment rail assembly 16 removably-attached to the body 12 or integrally-formed-with the body 12. In yet another implementation, the helmet system 10 may include a fluid gutter assembly 18. As will be described in the following disclosure, the helmet system 10′ is substantially similar to the helmet system 10; however, the exemplary configuration of the face shield assembly 14′ of the helmet system 10′ is defined by an optional configuration compared to the face shield assembly 14 of the helmet system 10.

In an example, as seen in FIG. 1, the body 12 may be generally defined by a dome portion 12a and a perimeter portion 12b integrally-extending from a lower end of the dome portion 12a. The dome portion 12a may be shaped to be arranged over or cover the top of a user's head whereas the perimeter portion 12b may be shaped to be arranged over or cover the sides of rear of the user's head while leaving a front or face region of the user's head exposed. In some instances, a chin strap member (not shown) may be secured to the perimeter portion 12b of the body 12 in order to removably-secure the body 12 to a head of a user about, for example, the chin and/or jaw region of the user's head.

The body 12 may be formed from any desirable material. In an example, the body 12 may be formed from a rigid material such as acrylonitrile butadiene styrene (ABS)) plastic. Although the body 12 may be formed from ABS plastic, the body 12 is not limited to being formed from ABS plastic, and, therefore, may be formed from any desirable material.

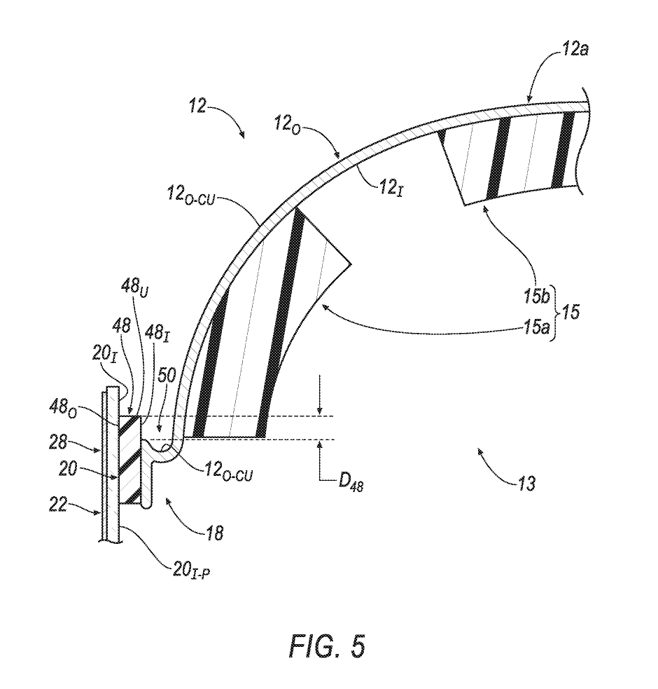

With continued reference to FIGS. 1 and 5, the inner surface 12_{I} of the body 12 may form a cavity 13 for receiving a head of a user. Furthermore, the cavity 13 may be shaped to receive one or more cushioning members 15 such as a first cushioning member 15a and a second cushioning member 15b. In an example, the first cushioning member 15a may be sized to be disposed between the inner surface 12_{I} of the body 12 and a forehead region and/or temporal regions of the head of the user. In other example, the second cushioning member 15b may be sized to be disposed between the inner surface 12_{I} of the body 12 and a top or scalp region, lateral regions and a rear region of the head of the user.

In an example, the one or more cushioning members 15 may be formed from a foam material. In some instances, hook-and-loop fasteners (e.g., VELCRO®, not shown) may be utilized for removably-securing the one or more cushioning members 15 to the inner surface 12_{I} of the body 12. In some instances, a loop of material (not shown) may be integrated with or formed into an outer surface of the one or more cushioning members 15 for securing the hook-and-loop fasteners thereto. In other implementations, the one or more cushioning members 15 may be slit, scored, shaped, cut or molded to include a plurality of grooves 17 that extend into an outer surface of the one or more cushioning members 15. The plurality of grooves 17 may define a pattern of, for example, intersecting lines that may form a grid for the purpose of permitting the one or more cushioning members 15 to bend from a substantially flat shape to a substantially non-flat shape or arcuate shape for conforming to a non-planar surface defined by the inner surface 12_{I} of the body 12 that forms the cavity 13.

Each cushioning member of the one or more cushioning members 15 may include one layer of cushioning material or a plurality of layers of cushioning material. In an implementation where the cushioning material is defined by a plurality of layers of cushioning material, at least a first layer of cushioning material of the plurality of cushioning layers arranged proximate a user's head is defined by a softer cushioning material than at least a second layer of cushioning material of the plurality of cushioning layers arranged proximate the inner surface 12_{I} of the body 12 that may be defined by a harder cushioning material. The softness and/or hardness of the cushioning material may be defined in terms of a Durometer.

In an example, each cushioning member of the one or more cushioning members 15 may be defined by plurality of layers of foam material. At least a first layer of foam material of the plurality of foam layers arranged proximate a user's head is defined by a softer foam material than at least a second layer of foam material of the plurality of foam layers arranged proximate the inner surface 12_{I} of the body 12 that may be defined by a harder foam material. In an example, the first layer of foam material may be defined by a thickness approximately equal to 0.625″ and the second layer of foam material may be defined by any desirable thickness ranging between, for example, 0.125″ and 0.25″.

In an example, the first layer of foam material may be defined by one or more of the following characteristics. The hardness of the first layer of foam material may be any desirable Durometer ranging between 45 Durometer and 65 Durometer. The density of the first layer of foam material may be any desirable density ranging between 0.09 g/cm³ and 0.12 g/cm³. The tensile strength of the first layer of foam material may be any desirable tensile strength approximately equal to, for example: 12 kg/cm². The tear strength of the first layer of foam material may be any desirable tear strength approximately equal to, for example: 5.5 kg/cm.

In an example, the second layer of foam material may be defined by one or more of the following characteristics. The hardness of the second layer of foam material may be any desirable Durometer ranging between 75 Durometer and 95 Durometer. The density of the second layer of foam material may be any desirable density ranging between 0.17 g/cm³ and 0.21 g/cm³. The tensile strength of the second layer of foam material may be any desirable tensile strength approximately equal to, for example: 22 kg/cm². The tear strength of the second layer of foam material may be any desirable tear strength approximately equal to, for example: 11 kg/cm.

In some implementations, adjacent layers of foam material defining the plurality of layers of foam material may be secured to one another with an adhesive material. In an example, the adhesive material may be a water-based neoprene adhesive material that is applied to each foam layer by a curtain coater with heat and pressure.

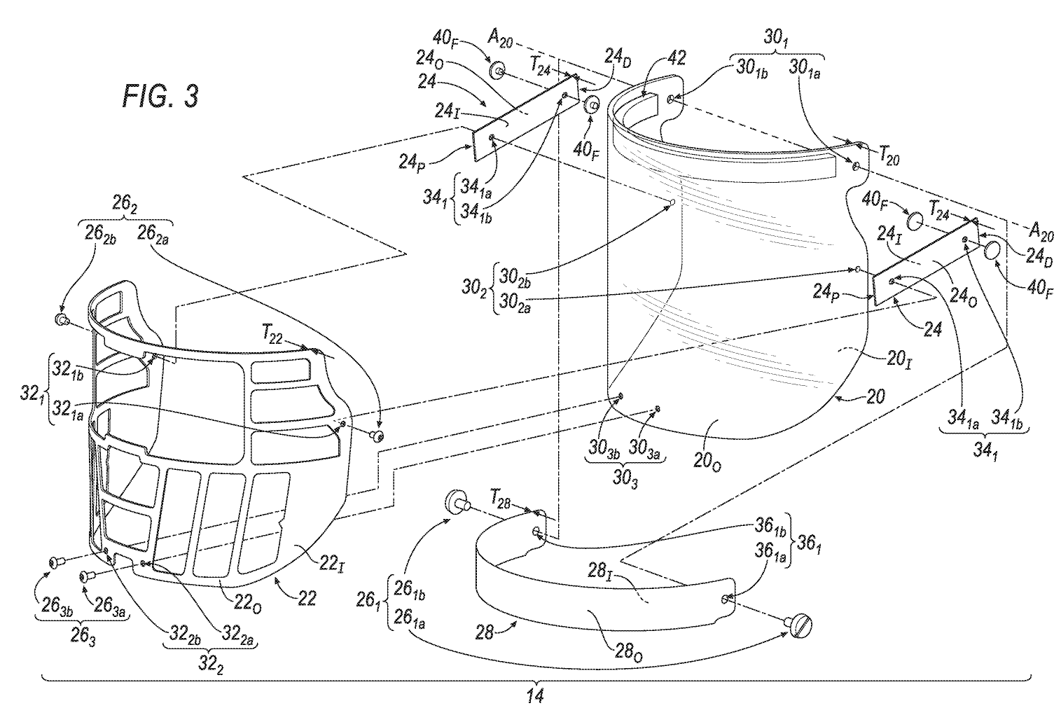

Referring to FIG. 3, the face shield assembly 14 may include one or more of the following components, being: a visor member 20, a face guard member 22 and one or more lock-down straps 24. The face shield assembly 14 may also include a plurality of fasteners 26₁, 26₂, 26₃ that may removably-secure the face guard member 22 to the visor member 20 and one or both of the visor member 20 and the face guard member 22 to the body 12. The face shield assembly 14 may also include an optional plate band 28.

The visor member 20 may be manufactured from any desirable plastic material having a transparent quality such that a user may see through the material defining the visor member 20. The face guard member 22 may be formed from any desirable material, such as, for example, metal. In some instances, the metal material defining the face guard member 22 may be shaped, cut, stamped or otherwise formed to define one or more viewer openings (so as to not obstruct vision or sightline of the user), branding, lettering, indicia, symbols, patterns or the like to thereby provide the face guard member 22 with a custom shape, design or appearance. In one example, metal material defining the face guard member 22 may be cut using, for example, a water jet cutting machine or a laser cutting machine. The use of a water jet cutting machine or a laser cutting machine permits that face guard member 22 from being shaped from one unit of material while also permitting the face guard member 22 to have any desirable custom shape, design or appearance.

As seen in FIG. 3, the visor member 20 is defined by a thickness T₂₀ extending between an outer surface 20_{O} of the visor member 20 and an inner surface 20_{I} of the visor member 20. The visor member 20 may define a plurality of visor fastener passages 30₁, 30₂, 30₃ extending through the thickness T₂₀ of the visor member 20 that are sized for receiving one or more of the plurality of fasteners 26₁, 26₂, 26₃.

The face guard member 22 is defined by a thickness T₂₂ extending between an outer surface 22_{O} of the face guard member 22 and an inner surface 22_{I} of the face guard member 22. The inner surface 22_{I} of the face guard member 22 is sized for being disposed adjacent or arranged over or arranged opposite the outer surface 20_{O} of the visor member 20. The face guard member 22 may define a plurality of face guard member passages 32₁, 32₂ extending through the thickness T₂₂ of the face guard member 22 that are sized for receiving one or more of the plurality of fasteners 26₁, 26₂, 26₃.

The one or more lock-down straps 24 may be defined by a pair of lock-down straps. Each lock-down strap 24 of the pair of lock-down straps is defined by a thickness T₂₄ extending between an outer surface 24_{O} of the one or more lock-down straps 24 and an inner surface 24_{I} of the one or more lock-down straps 24. A portion of the inner surface 24_{I} of the one or more lock-down straps 24 is sized for being disposed adjacent or arranged over or arranged opposite the outer surface 20_{O} of the visor member 20.

The one or more lock-down straps 24 may define a plurality of lock-down strap passages 34₁ extending through the thickness T₂₄ of the one or more lock-down straps 24 that are sized for receiving one or more of the plurality of fasteners 26₁, 26₂, 26₃. As will be described in the following disclosure, the plurality of lock-down strap passages 34₁ extending through the thickness T₂₄ of the one or more lock-down straps 24 may also be sized for receiving a female potion 40_{F} of a snap-fastener 40 for removably-securing the one or more lock-down straps 24 to the body 12, and, as a result, for removably-securing the face shield assembly 14 to the body 12.

The optional plate band 28 is defined by a thickness T₂₈ extending between an outer surface 28_{O} of the optional plate band 28 and an inner surface 28_{I} of the optional plate band 28. The inner surface 28_{I} of the optional plate band 28 is sized for being disposed adjacent or arranged over or arranged opposite a portion of the outer surface 20_{O} of the visor member 20. The optional plate band 28 may define a plurality of plate band passages 36₁ extending through the thickness T₂₈ of the optional plate band 28 that are sized for receiving one or more of the plurality of fasteners 26₁, 26₂, 26₃.

With reference to FIGS. 2A-2B and 3, the visor member 20 is rotatably-attached to the body 12 by a first pair of fasteners 26₁ of the plurality of fasteners 26₁, 26₂, 26₃. A first fastener 26₁ₐ (see FIGS. 2A and 3) and a second fastener 26_{1b} (see FIG. 3) of the first pair of fasteners 26₁ are respectively inserted through a first visor fastener passage 30₁ₐ (see FIG. 3) and a second visor fastener passage 30_{1b} (see FIG. 3) of a first pair of visor fastener passages 30₁ of the plurality of visor fastener passages 30₁, 30₂, 30₃. If the band plate 28 is optionally included, the first pair of fasteners 26₁ may optionally secure the band plate 28 to the visor member 20 by respectively arranging the first fastener 26₁ₐ and the second fastener 26_{1b} of the first pair of fasteners 26₁ through a first band plate passage 36₁ₐ (see FIG. 3) and a second band plate passage 36_{1b} (see FIG. 3) of the plurality of plate band passages 36₁.

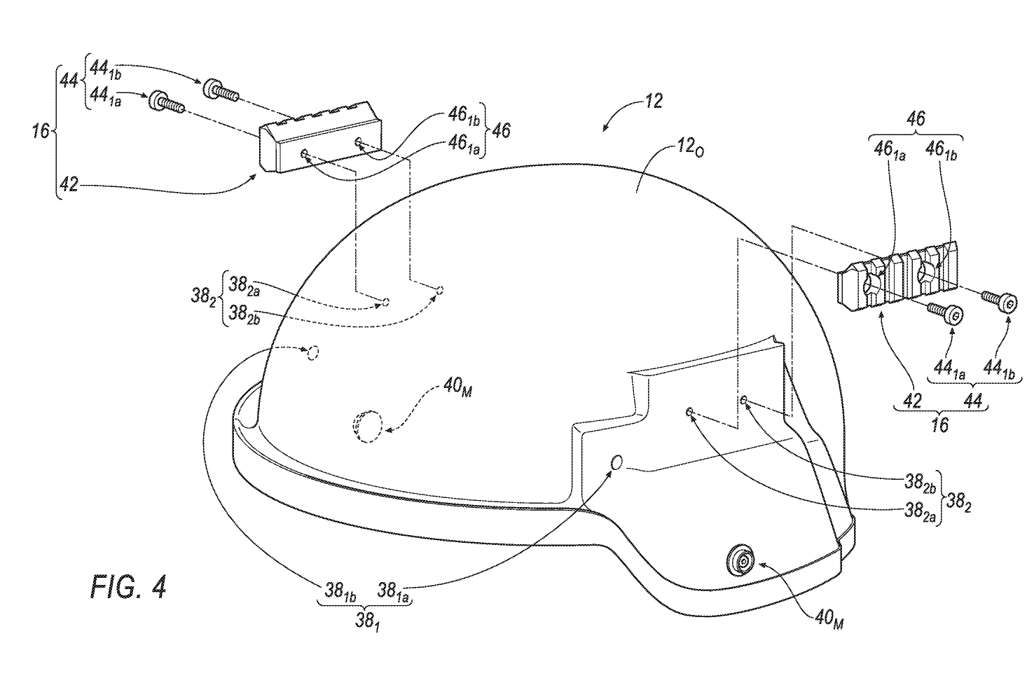

The first fastener 26₁ₐ and the second fastener 26_{1b} of the first pair of fasteners 26₁ are subsequently received by a corresponding first pair of fastener passages 38₁ (see, e.g., FIG. 4) defined by a first fastener passage 38₁ₐ and a second fastener passage 38_{1b} that extend into the outer surface 12_{O} of the body 12 for rotatably-attaching at least the visor member 20 of the face shield assembly 14 to the body 12. As seen in FIGS. 2A-2B and 3, an axis A₂₀-A₂₀ extends through an axial center of the first fastener 26₁ₐ and the second fastener 26_{1b} of the first pair of fasteners 26₁ as well as an axial center of the first fastener passage 38₁ₐ and a second fastener passage 38_{1b} of the first pair of fastener passages 38₁ that extend into the outer surface 12_{O} of the body 12 such that at least the visor member 20 of the face shield assembly 14 may be rotatably-arranged in one of a down orientation (see, e.g., FIG. 2A) and an up orientation (see, e.g., FIG. 2B).

As seen in FIG. 3, a first fastener 26₂ₐ and a second fastener 26_{2b} of a second pair of fasteners 26₂ are respectively inserted through a first face guard passage 32₁ₐ and a second face guard passage 32_{1b} of a first pair of face guard passages 32₁ of the plurality of face guard passages 32₁, 32₂ formed by the face guard 22. The first fastener 26₂ₐ is subsequently passed through a first lock-down strap passage 34₁ₐ of the plurality of lock-down strap passages 34₁ formed by the first lock-down strap 24 for securing the first lock-down strap 24 to the face guard 22. The second fastener 26_{2b} is subsequently passed through a first lock-down strap passage 34₁ₐ of the plurality of lock-down strap passages 34₁ formed by the second lock-down strap 24 for securing the second lock-down strap 24 to the face guard 22. In an optional configuration, the first fastener 26₂ₐ and the second fastener 26_{2b} of the second pair of fasteners 26₂ may be then further passed through a first visor fastener passage 30₂ₐ and a second visor fastener passage 30_{2b} of a second pair of visor fastener passages 30₂ of the plurality of visor fastener passages 30₁, 30₂, 30₃ for securing the face guard 22 and the first and second lock-down straps 24 to the visor member 20; in such an optional configuration, the face guard 22 is joined to the visor member 20 such that the face guard 22 is rotatably-arranged with the visor member 20 in one of the down orientation (see, e.g., FIG. 2A) and the up orientation (see, e.g., FIG. 2B).

With continued reference to FIG. 3, in another optional configuration, a first fastener 26₃ₐ and a second fastener 26_{3b} of a third pair of fasteners 26₃ are respectively inserted through a first face guard passage 32₂ₐ and a second face guard passage 32_{2b} of a second pair of face guard passages 32₂ of the plurality of face guard passages 32₁, 32₂ formed by the face guard 22. The first fastener 26₃ₐ and the second fastener 26_{3b} are subsequently passed through a first visor fastener passage 30₃ₐ and a second visor fastener passage 30_{3b} of a third pair of visor fastener passages 30₃ of the plurality of visor fastener passages 30₁, 30₂, 30₃ for securing the face guard 22 to the visor member 20. In such an optional configuration, the face guard 22 is joined to the visor member 20 such that the face guard 22 is rotatably-arranged with the visor member 20 in one of the down orientation (see, e.g., FIG. 2A) and the up orientation (see, e.g., FIG. 2B).

With reference to FIG. 3, each of the first lock-down strap 24 and the second lock-down strap 24 of the one or more lock-down straps 24 is defined by a proximal end 24_{P} and a distal end 24_{D}. The proximal end 24_{P} of each of the first lock-down strap 24 and the second lock-down strap 24 of the one or more lock-down straps 24 is secured to at least the face guard 22 with the first fastener 26₂ₐ and the second fastener 26_{2b} of a second pair of fasteners 26₂ as described above. The distal end 24_{D} of each of the first lock-down strap 24 and the second lock-down strap 24 of the one or more lock-down straps 24 defines a second lock-down strap passage 34_{1b} of the plurality of lock-down strap passages 34₁. The second lock-down strap passage 34_{1b} of each of the first lock-down strap 24 and the second lock-down strap 24 of the one or more lock-down straps 24 is sized to receive, for example, a female potion 40_{F} of a snap-fastener 40 (see, e.g., FIG. 1) that may be selectively-secured to a male portion (see, e.g., 40_{M} in FIGS. 1 and 4) of the snap-fastener 40 that is disposed upon or secured to the outer surface 12_{O} of the body 12.

With reference to FIGS. 2A-2B, a method of operating the face shield assembly 14 of the helmet system 10 is described. As seen in FIG. 2A, the female potion 40_{F} of the snap-fastener 40 is selectively joined to the male portion 40_{M} of the snap-fastener 40 such that the face shield assembly 14 is movably-secured to the body 12 in the down orientation. If the user desired to arrange the face shield assembly 14 in the up orientation relative the body 12, the user firstly unfastens the one or more snap-fasteners 40 by separating the female potion 40_{F} from the male portion 40_{M} thereby detaching, according to the direction of arrow D1, each of the first and second lock-down straps 24 of the pair of lock-down straps from the body 12. Then, the user may pivot the visor member 20 and the face guard 22 secured thereto about the axis A₂₀-A₂₀ according to the direction of arrow D2 for arranging the face shield assembly 14 in the up orientation as seen in FIG. 2B.

With reference to FIGS. 2A′-2C′, a method of operating the face shield assembly 14′ of the helmet system 10′ is described. Unlike the face shield assembly 14 of the helmet system 10 described above, the face shield assembly 14′ is arranged in a configuration whereby the face guard 22′ is not attached to the visor member 20′ with fasteners (e.g., as seen and described above, the first fastener 26₂ₐ and the second fastener 26_{2b} of the second pair of fasteners 26₂ and the first fastener 26₃ₐ and the second fastener 26_{3b} of the third pair of fasteners 26₃ that secure the face guard 22 to the visor member 20). Furthermore, although other aspects of the helmet system 10′ (e.g., an implement attachment rail assembly 16′ and a fluid gutter assembly 18′) are not described here, the helmet system 10′ includes all of the features associated with the helmet system 10 described in the present disclosure, and, therefore, the illustrated helmet system 10′ includes like reference numerals that are distinguished by a prime symbol (′).

As seen in FIG. 2A′, the female potion 40F′ of the snap-fastener 40′ is selectively joined to the male portion 40_{M}′ of the snap-fastener 40′ such that the face shield assembly 14′ is movably-secured to the body 12′ in the down orientation. According to the exemplary configuration associated with the helmet system 10′, when the face guard 22′ is removably-secured to the body 12′ with the snap fasteners 40′, the face guard 22′ prevents the visor member 20′ from being deployed from the down orientation (see, e.g., FIG. 2A′) to the up orientation (see, e.g., FIG. 2C′) until the face guard 22′ is detached from the body 12′ (see, e.g., FIG. 2B′).

Accordingly, with reference to FIG. 2A′, if the user desires to arrange the face shield assembly 14′ in the up orientation relative the body 12′, the user firstly unfastens the one or more snap-fasteners 40′ by separating the female potion 40F′ from the male portion 40_{M}′ thereby detaching, according to the direction of arrow D1′, each of the first and second lock-down straps 24′ of the pair of lock-down straps from the body 12′. As seen in FIG. 2B′, because the face guard 22′ is not fastened to the visor member 20′ in a similar manner as the face guard 22 being fastened to the visor member 20, the face guard 22′ (that includes the first and second lock-down straps 24′ attached thereto) is removed from the body 12′ according to the direction of arrow D2′. Then, as seen in FIG. 2B′-2C′, because the face guard 22′ is not arranged over or adjacent the visor member 20′ for otherwise interfering with movement of the visor member 20′ from the down orientation to the up orientation, the user may rotate the visor member 20′ about the axis A₂₀′-A₂₀′ according to the direction of arrow D3′ from the down orientation to the up orientation.

Referring to FIGS. 1 and 4, the helmet system 10 may include one or more implement attachment rail assemblies 16. As seen in FIG. 4, each implement attachment rail assembly 16 may include attachment rail member 42 and a pair of fasteners 44₁ defined by a first fastener 44₁ₐ and a second fastener 44_{1b}. Each attachment rail member 42 may be defined a first pair of attachment rail member passages 46₁ including a first attachment rail member passage 46₁ₐ and a second attachment rail member passage 46_{1b}.

The first fastener 44₁ₐ and the second fastener 44_{1b} of the pair of fasteners 44₁ are respectively inserted into the attachment rail member passage 46₁ₐ and the second attachment rail member 46_{1b} of the pair of fasteners 46₁ formed by the attachment rail member 42. Thereafter, the first fastener 44₁ₐ and the second fastener 44_{1b} of the pair of fasteners 44₁ of each implement attachment rail assembly 16 are subsequently received by a corresponding second pair of fastener passages 38₂ (see, e.g., FIG. 4) defined by a first fastener passage 38₂ₐ and a second fastener passage 38_{2b} that extend into the outer surface 12_{O} of the body 12 for removably-attaching each attachment rail member 42 of each implement attachment rail assembly 16 to the body 12.

Each attachment rail member 42 may include any desirable shape or cross-sectional geometry corresponding to a mounting groove or mounting channel of an implement I (see, e.g., FIGS. 2A-2B, FIGS. 2A′-2C′). In an example, one or more of the attachment rail members 42 may define a Picatinny style shape. In another example, one or more of the attachment rail members 42 may define a dovetail cross-sectional geometry. Implements I that may be removably-secured to the one or more of the attachment rail members 42 may include, for example, a flashlight, a camera or the like.

Referring to FIGS. 1 and 5, the helmet system 10 may include a fluid gutter assembly 18. In an example, the fluid gutter assembly 18 may be generally defined by one or more of an arrangement of a face shield assembly seal member 48 (see, e.g., FIGS. 1 and 5) and a shape or curvature of the body 12 that defines a fluid trough or fluid channel 50 (see, e.g., FIG. 5).

In an example, as seen in FIG. 1, the face shield assembly seal member 48 may be generally defined by an arcuate shape having an inner surface 48_{I} and an outer surface 48_{O}. As seen in FIG. 5, the outer surface 48_{O} of face shield assembly seal member 48 may be secured to, for example, the inner surface 20_{I} of the visor member 20 with, for example, an adhesive. When the face shield assembly 14 is arranged in the down orientation (as seen in, e.g., FIG. 5), an uppermost surface 48_{U} of the face shield assembly seal member 48 may extend at a distance D₄₈ above an uppermost surface of the fluid trough or fluid channel 50 in order to mitigate fluid (e.g., rain water) from entering a region of the face shield assembly 14 defined by a portion 20_{I-P} of the inner surface 20_{I} of the visor member 20 for mitigating intrusion of elements from the surrounding environment into a region of space defined in part by the portion 20_{I-P} of the inner surface 20_{I} of the visor member 20 that is opposite a user's face region.

With continued reference to FIG. 5, the fluid trough or fluid channel 50 may be formed by the outer surface 12_{O} of the body 12. In an example, the outer surface 12_{O} of the dome portion 12a of the body 12 may be generally defined by a concave-down outer surface portion 12_{O-CD}. However, a lower-most perimeter of the outer surface 12_{O} of the dome portion 12a of the body 12 that does not transition to a perimeter portion 12b of the body 12 may be defined by a concave-up outer surface portion 12_{O-CU}. In an example, the concave-up outer surface portion 12_{O-CU} may at least partially define the fluid trough or fluid channel 50 and be shaped to collect fluid (e.g., rain water). Furthermore, in some instances, the fluid trough or fluid channel 50 may be defined by the concave-up outer surface portion 12_{O-CU} in combination with the face shield assembly seal member 48 extending at the distance D₄₈ above an upper-most surface portion of the concave-up outer surface portion 12_{O-CU}.

In other examples, the concave-up outer surface portion 12_{O-CU} may be shaped to direct such fluid toward the perimeter portion 12b of the body 12 in order to mitigate the fluid from travelling toward the portion 20_{I-P} of the inner surface 20_{I} of the visor member 20 that is opposite the user's face region. In one example, the concave-up outer surface portion 12_{O-CU} may be shaped to include a pitch or grade whereby the concave-up outer surface portion 12_{O-CU} may pitch the fluid toward the perimeter portion 12b of the body 12.

Although an implementation of the concave-down outer surface portion 12_{O-CD} of the outer surface 12_{O} of the body 12 transitions to a concave-up outer surface portion 12_{O-CU}, the fluid trough or fluid channel 50 may be defined by other configurations. In an example, the region defined by the concave-down outer surface portion 12_{O-CD} may alternatively be shaped to define a substantially flat surface instead of a concave-up orientation whereby the substantially flat surface in combination with the face shield assembly seal member 48 extending at the distance D₄₈ above the substantially flat surface collectively defines the fluid trough or fluid channel 50.

A number of implementations have been described. Nevertheless, it will be understood that various modifications may be made without departing from the spirit and scope of the disclosure. Accordingly, other implementations are within the scope of the following claims.

What is claimed is:

1. A helmet system, comprising:
a body sized for being arranged upon a head of a user; and
a face shield assembly including:
a visor member rotatably-attached to the body,
a face guard member arranged over the visor member, and
at least one lock-down strap, wherein a first end of the at least one lock-down strap is connected to the face guard member, wherein a second end of the at least one lock-down strap is selectively-attached to the body.

2. The helmet system according to claim 1, wherein at least one fastener connects the face guard member to the visor member.

3. The helmet system according to claim 1, wherein at least one fastener extends through each of the face guard member, the at least one lock-down strap and the visor member.

4. The helmet system according to claim 1, further comprising:
a pair of fasteners that rotatably-attach the visor member to the body.

5. The helmet system according to claim 4, further comprising:
a plate band arranged over the visor member, wherein the pair of fasteners extend through the plate band for attaching the plate band to the visor member.

6. The helmet system according to claim 1, wherein the face guard defines a plurality of openings formed from one unit of material.

7. The helmet system according to claim 6, wherein the plurality of openings are formed by a water jet cutting machine.

8. The helmet system according to claim 6, wherein the plurality of openings are formed by a laser cutting machine.

9. The helmet system according to claim 1, wherein the body is formed from an acrylonitrile butadiene styrene material.

10. The helmet system according to claim 1, further comprising:
one or more cushioning members, wherein an inner surface of the body forms a cavity that is shaped for receiving the one or more cushioning members defining a plurality of grooves configured to permit the one or more cushioning members to bend from a substantially flat shape to a substantially non-flat shape for conforming to a non-planar surface defined by the inner surface of the body.

11. The helmet system according to claim 10, wherein the one or more cushioning members is defined by a plurality of layers of cushioning material having at least a first layer of cushioning material and a second layer of cushioning material, wherein the first layer of cushioning material is defined by a first Durometer ranging between 45 Durometer and 65 Durometer, wherein the second layer of cushioning material is defined by a second Durometer ranging between 75 Durometer and 95 Durometer.

12. The helmet system according to claim 1, further comprising:
an implement attachment rail member extending from an outer surface of the body.

13. The helmet system according to claim 12, wherein the implement attachment rail member is a Picatinny rail member.

14. A helmet system, comprising:
a body having a dome portion and a perimeter portion extending from the dome portion; and
a fluid gutter extending along a lower perimeter of the dome portion.

15. The helmet system of claim 14, wherein the fluid gutter is defined by a channel formed by an outer surface of the body having a concave-up outer surface portion.

16. The helmet system of claim 14, wherein the concave-up outer surface portion is defined by a grade extending between a high point of the concave-up outer surface portion and a lower point of the concave-up outer surface portion whereby the lower point of the concave-up outer surface portion is located proximate the perimeter portion of the body for directing fluid toward the perimeter portion of the body.

17. The helmet system of claim 14, further comprising:
a face shield assembly including a visor member rotatably-attached to the body; and
a face shield assembly seal member secured to an inner surface of the visor member, wherein the fluid gutter is defined by the face shield assembly seal member and a portion of an outer surface of the body whereby an uppermost surface of the face shield assembly seal member extends at a distance above the portion of the outer surface of the body defining the lower perimeter of the dome portion.

18. The helmet system of claim 17, wherein the portion of the outer surface of the body defining the lower perimeter of the dome portion is defined by a concave-up surface portion.

19. A method, comprising:
providing a helmet system including a visor member of a face shield assembly rotatably-attached to a body that is sized for being arranged upon a head of a user;
arranging a face guard member of the face shield assembly over an outer surface of the visor member; and
removably-connecting at least one lock-down strap extending from the face guard member to the body for:
securing the face guard member of the face shield assembly to the body, and
rotatably-securing the visor member of the face shield assembly in a down orientation relative the body.

20. The method according to claim 19, further comprising:
securing the face guard member to visor member;
detaching the at least one lock-down strap from the body; and
rotating the visor member and the face guard secured thereto from the down orientation relative the body to an up orientation relative to the body.

21. The method according to claim 19, further comprising:
detaching the at least one lock-down strap from the body;
arranging the face guard member away from the outer surface of the visor member; and
rotating the visor member from the down orientation relative the body to an up orientation relative to the body.

22. The method according to claim 19, further comprising:
attaching an implement to an implement attachment rail member extending from an outer surface of the body.
